(19) United States
(12) Patent Application Publication
(10) Pub. No.: US 2004/0183904 A1
(43) Pub. Date: Sep. 23, 2004

(54) Enhanced, downlink-capable, fire-data gathering and monitoring

(76) Inventor: David A. Johnson, Jefferson, OR (US)

Correspondence Address: ROBERT D. VARITZ, P.C., 2007 S.E. Grant Street, Portland, OR, 97201, US

(21) Appl. No.: 10/798,806

(22) Filed: Mar. 10, 2004

Related U.S. Application Data
(60) Provisional application No. 60/456,978, filed on Mar. 23, 2003.

(51) Int. Cl. H04N 7/18

(52) U.S. Cl. 348/144; 340/584; 382/103

(57) ABSTRACT

Apparatus and a method involving airborne ground-fire data-gathering for overlay mapping and fire-control purposes. From a methodologic point of view, the method includes, from an airborne platform, (a) gathering, for visual presentation and viewing purposes, related optical and thermal fire-perimeter data, (b) gathering critical-alignment evaluation data, such as air temperature, relative humidity, wind direction and speed, which is associated with and relevant to such optical and thermal data, and transmitting all of such data, effectively in a geophysically-linked manner, to a remote site for map-display viewing and evaluation. The method further includes applying to such gathered data selected critical-alignment, severity-scale parameters which are employable generally to rank, from lower to higher, fire severity conditions in terms of prioritizing the deployment of fire-fighting resources, and from, and on the basis of, such applying, effectively map-highlighting, also for viewing and evaluation, selected parts of the gathered data which indicate certain higher-severity fire conditions.

### CROSS REFERENCE TO RELATED APPLICATION

This application claims priority to prior-filed, currently copending U.S. Provisional Patent Application Serial No. 60/456,958, filed Mar. 23, 2003 for “Enhanced, Downlink-Capable, Fire-Data Gathering and Monitoring” by David A. Johnson. The entire contents of that provisional application are hereby incorporated herein by reference.

### BACKGROUND AND SUMMARY OF THE INVENTION

This invention pertains to ground-fire management, and in particular to an airborne method which results in the digital transmission, to a suitable ground station, of ground fire perimeter data including different isothermal conditions that lie along the length of such a line, accompanied by so-called critical-alignment data which can be used to prioritize and focus the utilization of ground-fire fighting resources. A preferred embodiment of and manner of practicing the present invention are described in conjunction with gathering data from an airborne support platform, such as the frame of an over-flying helicopter, a situation in which the present invention has been found to offer particular utility.

Prior-issued U.S. Pat. No. 5,160,842, issued on Nov. 3, 1992, describes what is referred to in that patent as infrared fire-perimeter mapping. This patent describes the background against which the present invention has been created. In that patent, the entirety of which is hereby incorporated herein by reference, a system and a methodology are described wherein an over-flying aircraft, such as a helicopter, acquires both thermal and optical data which is positionally coordinated, and aimed at producing data streams that allow for the overlay printing, if so desired, on a common topographic map, for example, of the observed perimeter line of a ground fire, with that line marked or distinguished in any suitable manner along regions of its length to highlight different isothermal conditions existing along that line.

The present invention augments the structure and methodology disclosed in that patent in several significant ways. To begin with, the apparatus of the present invention is constructed in such a fashion that a thermal imager and an optical imager carried in an over-flying airborne structure, such as a helicopter, can be angulated to an infinite different number of angles about a gravity line axis, and can also be tilted upwardly and downwardly through an infinite number of angles. This arrangement allows for the easy overhead observation of many regions along a fire line from a substantially common overhead location.

Another very important feature of the present invention is that the system and methodology of the invention propose the gathering of so-called critical-alignment data which include air temperature, relative humidity, and wind speed and direction. GPS data is also integrated with all captured data so that the relative positions between a particular point along a fire line, and the site of the observing overhead structure, are known quite accurately in space relative to one another. Critical-alignment data is that important collection of data which, when combined with fire perimeter isothermal data, can significantly aid in the direction and utilization of best-available fire fighting resources to deal with conditions along a fire line that need priority attention.

These and other features and advantages which are attained by the present invention will become more fully apparent as the description which now follows is read in conjunction with the accompanying drawings.

### DESCRIPTION OF THE DRAWINGS

FIG. 1 is a block/schematic diagram illustrating generally all of the componentry, (airborne and ground-sited) which make up the system of the present invention.

FIG. 2 is a very simplified downwardly looking plan view of a portion of a ground fire showing a pair of common-elevation topographic lines which are intersected in various ways by a fragmentarily shown fire line. Also pictured in FIG. 2, in a very simplified manner, is an airborne support platform in the form of an over-flying helicopter which is utilizing what is referred to in FIG. 1 as the aircraft-carried structural portions of the system of the invention.

FIG. 3 isolates the fire line shown in FIG. 2, with regions along the line marked to indicate representative isothermal stretches along the line.

In both FIGS. 2 and 3, somewhat enlarged black dots (three of them) lie along the fire line to represent particular points along that line wherein, as will be explained below, priority-attention regions have been noted in accordance with practice of the present invention.

FIG. 4 relates to FIGS. 2 and 3, and illustrates, along with these two other figures, the infinite angular adjustability which is provided in accordance with this invention with respect to two, substantially common line-of-site imagers including a thermal imager and an optical imager. This drawing figure is also employed to picture the different line-of-sight distances which exist between the observing helicopter and the three priority-noted points along the fire line.

### DETAILED DESCRIPTION OF THE INVENTION

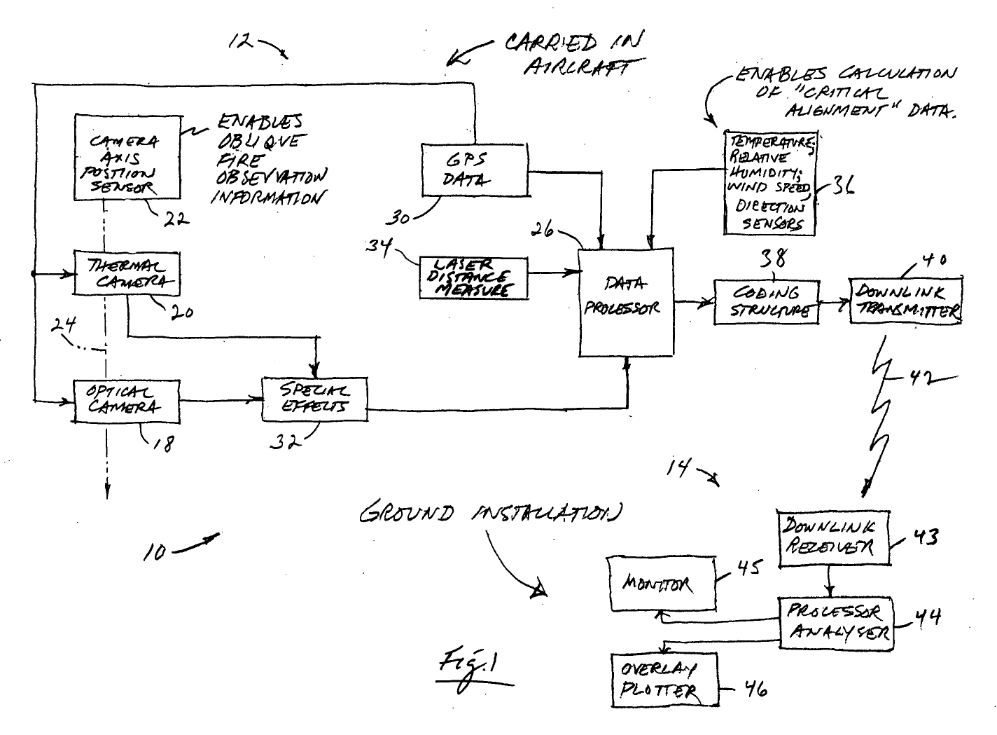

Turning now to the drawings, and referring first of all to FIG. 1, FIG. 1 in its entirety shows generally at 10 an airborne-based ground-fire management system which incorporates and employs a preferred and best-mode embodiment of the present invention. System 10 is also referred to herein as apparatus for temperature and critical-alignment evaluation mapping and remote reporting. Generally speaking, system 10 includes airborne componentry 12, also labeled generally “Carried In Aircraft”, and a remote ground installation 14 located at an appropriate ground site which is stationed, by selection, somewhere in the vicinity of a ground fire which is being addressed. While there are many manners in which the airborne componentry which operates in accordance with the present invention can be deployed overhead a ground fire, for purposes of illustration herein, this componentry is described as being carried appropriately aboard a helicopter 16 (see FIG. 2) which includes a frame 16a (also illustrated in FIG. 2). Frame 16a is also referred to herein as an airborne support platform.

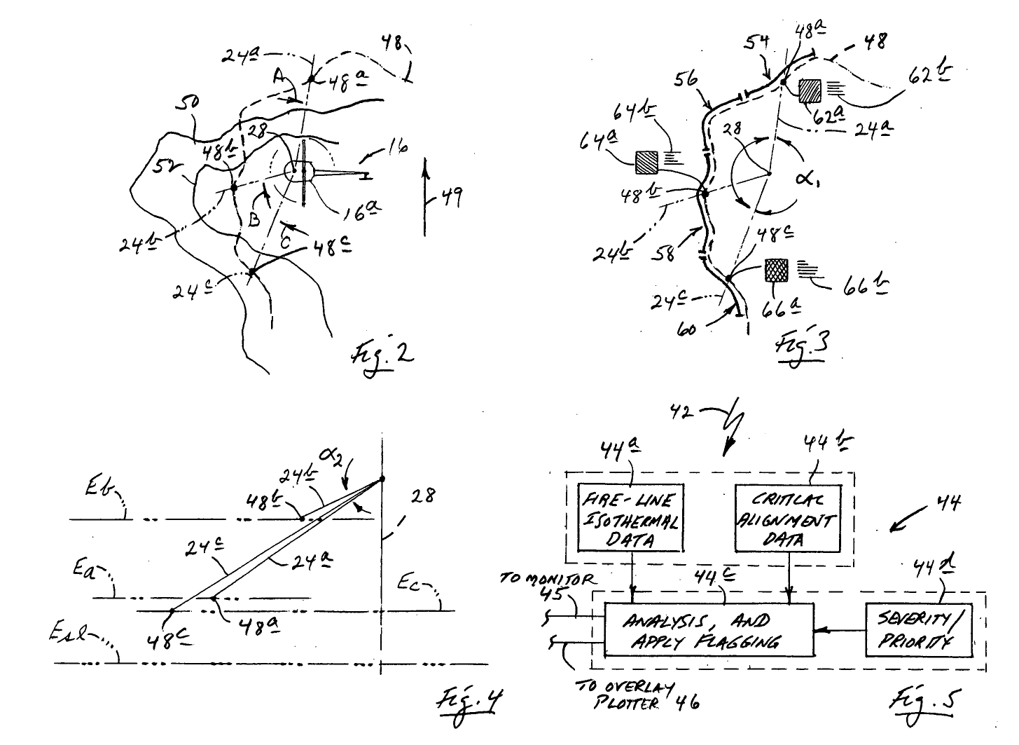

Airborne componentry 12 is represented schematically in FIG. 1 in the form of ten different operatively interconnected labeled blocks. Included in the componentry of airborne structure 12 are an optical video camera, or optical imaging structure 18, a thermal camera, or thermal imaging structure 20, and a camera axis position sensor 22. Cameras 18, 20 are effectively locked together for coordinated positional movement as a unit, whereby they essentially share what is referred to herein as a substantially common view axis, or line-of-sight, represented in FIG. 1 by dash-double-dot line 24. Position sensor 22 is appropriately associated with cameras 18, 20 to produce an appropriate data stream which is indicative of the angular position in space of that common view axis. Sensor 22 is also referred to herein as structure for reporting the angle of the mentioned line-of-sight. An appropriate data-communication path, not specifically illustrated in FIG. 1, is provided for supplying this angular position data appropriately to a central data processor in structure 12, which processor is illustrated by block 26 in FIG. 1. With reference just for a moment to FIGS. 2, 3 and 4, this angular positioning capability which is provided, in any suitable conventional manner, for cameras 18, 20 is reflected by the angles generally indicated at α₁ and α₂ in FIGS. 3 and 4. Angle α₁ indicates the capability of adjusting view axis 24 substantially infinitely and horizontally in 360-degrees around a gravity line which is shown at 28 in FIGS. 2, 3, and 4. Angle α₂ reflects the capability of the appropriate mounting which is provided for the two cameras for angulation infinitely within a vertical plane which contains gravity line 28.

Cameras 18, 20, and position sensor 22, are entirely conventional individually in construction, and accordingly, details of these individual structures are not provided herein, inasmuch as they form no part of the present invention.

Also included in airborne componentry 12 is a conventional geophysical position sensor, or sensing structure, (GPS) 30 which furnishes spatial GPS information to cameras 18, 20, and also to data processor 26.

Optical and thermal imagery output data from cameras 18, 20 is supplied through a conventional special effects unit 32 to data processor 26. This output data which is supplied from unit 32 to processor 26 may also, at one's option, be supplied to one or more appropriate on-board thermal and/or optical monitors, and may also be fed appropriately to a suitable image recording device. Unit 32, as was mentioned, is a conventional unit, and this unit is designed to produce a proper common-time-base visual overlay relationship between the thermal and optical imagery derived from cameras 18, 20. This arrangement enables such imagery to be overlaid effectively on a common viewable print, such as an overlay print on a topographic map of the region from which the imagery is derived.

Further associated with camera 18, 20 for determining the distance along axis 24 between these cameras and any particular central point on the ground at which the cameras are looking, is a conventional laser distance measuring device represented by a block 34 in FIG. 1. Data from this distance measuring device is also appropriately supplied to processor 26.

Illustrated by a block 36 in FIG. 1, within componentry collection 12 is conventional structure which is armed with appropriate sensors for detecting important “atmospheric” data which is relevant to the issue mentioned earlier referred to as critical alignment. Block 36 is also referred to herein both as atmospheric-condition sensing structure, and as critical-alignment data gathering structure. Thus, block 36 represents appropriate sensors for detecting current air temperature, current relative humidity, and current wind direction and speed. Each of these categories of data is appropriately supplied to previously mentioned data processor 26, and it is this data which enables practice of the present invention to link so-called critical-alignment data with regions along the perimeter of a ground fire which may require special prioritized attention, depending upon the severity of fire conditions which may be indicated. As will be mentioned shortly herein, an appropriate set of rules and/or conditions (criteria) are utilized with respect to all of the data gathered by practice of the present invention in order to determine and mark areas along a fire perimeter which require such special attention.

In one data-communication form or another, which may be entirely conventional in nature, all of the data mentioned so far which is supplied to data processor 26 is handled within this data processor as digital data. Processed digital output data from processor 26 is supplied to an appropriate transmission coding structure represented by a block 38, and thence sent via a downlink transmitter 40 to componentry which is located at previously mentioned remote ground installation 14 shown in FIG. 1. Data downlink transmission is represented in FIG. 1 by the jagged arrow line shown at 42.

Considering the componentry which makes up the collection thereof shown at 14 in FIG. 1, at the mentioned remote ground installation, included here are a downlink receiver 43, a digital processor/analyzer 44, a video monitor 45, and an overlay plotter/printer 46. Receiver 43 receives transmissions from transmitter 40, and supplies these to processor/analyzer 44 which decodes this information to produce appropriate data output streams for supply each to monitor 45 and to plotter/printer 46. Typically, the apparatus thus shown generally at 14 in FIG. 1 is located at a ground site where fire-management command control is centered with respect to a particular ground fire.

Describing a bit more here about the make-up and operation of processor/analyzer 44, and referring to FIG. 5 in the drawings, this device is illustrated in FIG. 5 as including two collections of componentry placed in upper and lower dashed-outline blocks. In the upper block, there are shown two sub-blocks 44a, 44b which, respectively, decode and make available fire-line isothermal data, and critical alignment data, contained in downlink transmission 42. As will be seen, the fire-line isothermal data is derived ultimately from camera 20, and is handled by sub-block 44a to report regions of isothermal character distributed along the length of a ground-fire perimeter line. Sub-block 44b focuses attention on the elements of the previously mentioned critical-alignment data which are downlink-transmitted, including current information relative to air temperature, relative humidity, and wind direction and speed in the vicinity of helicopter 16 which contains cameras 18, 20. Considering what takes place in the lower dashed-outline block in FIG. 5, outputs from these two first mentioned sub-blocks are fed to a sub-block 44c which is labeled “Analysis, and Apply Flagging” in FIG. 5. It is within this sub-block 44c that rules and criteria for associating critical-alignment data with fire-line isothermal data are applied, as such rules and criteria are supplied by a sub-block 44d labeled “Severity/Priority”. These rules and criteria are matters completely of user selection and choice. They are the rules and criteria which determine whether and where particular regions along a ground fire line are to be treated as critical conditions in relation to current isothermal conditions and critical-alignment data, thus to justify focusing special attention in terms of the application of fire-fighting resources. One can think of this determination as one which sets priorities for fire-management attention in accordance with perceived severity of fire risk conditions at such regions along a fire line.

Turning attention now more specifically to FIGS. 2-4, inclusive, FIG. 2 represents a downwardly looking plan view, taken essentially along gravity line 28, illustrating helicopter 16 in a position overhead an existing ground fire which has a perimeter line partially shown by dashed line 48 in FIGS. 2 and 3. A north-pointing arrow is shown at 49. As can be seen particularly in FIG. 2, this fire line “snakes its way” along the topography of the immediate underlying ground, across representational topographic lines which are shown by two, fragmentary, irregular, solid lines 50, 52 in FIG. 2. For the purpose of the present explanation, it will be assumed that to the right generally of fire line 48 the subject ground fire has already burned available fuel, and that unburned fuel resides effectively to the left, and somewhat above this line, as such is shown in FIGS. 2 and 3. Another assumption with respect to the manner in which FIG. 2 is drawn is that topographic line 50 represents an elevation above sea level which is somewhat lower than that represented by topographic line 52.

With the system and methodology of the present invention at work in helicopter 16, the helicopter is appropriately flown and positioned over a region of the ground fire, such as is pictured generally in FIG. 2. From this point in space, and because of the multi-angular articulation capability which is afforded the positioning of view axis 24 with respect to cameras 18, 20, it is entirely possible for these cameras to be aimed in such a fashion that they can comprehensively view a relatively long stretch of the underlying fire line without requiring the helicopter to reposition itself significantly. Especially aiding in this is the articulation mentioned for the mounting of the cameras, whereby fire-line conditions, with respect to isothermal regions along that line, can be viewed with significant accuracy without the helicopter having to be in a position wherein the cameras must look directly or straight down at the fire line.

For purposes of illustration herein, three particular view lines, or positions, for common view axis 24 are shown in FIGS. 2, 3 and 4 by lines 24a, 24b, 24c. In FIGS. 2 and 3 these three lines are represented by dash-double-dot lines. In FIG. 4 they are represented by solid lines.

From the position of helicopter 16 shown in FIG. 2, these three lines, 24a, 24b, 24c effectively direct central attention to three points, or regions, 48a, 48b, 48c, respectively, distributed at spaced locations along line 48, and very specifically at different elevations above sea level as determined by the topography of the underlying ground. As can be seen in FIG. 4, lines 24a, 24b, 24c, in terms of their lengths which measure the distances between helicopter 16 and ground points 48a, 48b, 48c, respectively, are different, with the distance represented by lines 24b being the shortest distance, that represented by line 24a being the intermediate-length distance, and that represented by line 24c being the longest distance. In FIG. 4, lines 24a, 24b, 24c are presented in a common vertical plane, and the points of view taken, respectively, for these lines are indicated generally by the A, B and C arrows presented in FIG. 2. Further with respect to FIG. 4, the different ground-fire points 48a, 48b, 48c are shown to reside at different elevations Eₐ, E_{b}, E_{c} above sea level, with sea level being represented by a dash-triple-dot line Eₛₗ.

In FIG. 3 which isolates fire line 48 for consideration, four different stretches, or lengths, 54, 56, 58, 60 are generally illustrated distributed along this line. These four lengths, or regions, along line 48 are marked representationally in FIG. 3 to illustrate a condition where each of these lengths possesses, generally speaking, a different isothermal condition. In the presentation which is made available after data processing performed in accordance with practice of the present invention, both aboard an overhead aircraft and at a ground site, these regions of fire line 48 will appropriately be marked with different line characters, colors, etc., in order to indicate the presences of different isothermal conditions. The specific manner of marking such lengths of a fire line to indicate different isothermal conditions is completely a matter of user choice in terms of the granularity of information and the manner of visual presentation. Previously mentioned U.S. Pat. No. 5,160,842 describes this situation in detail.

Additionally contributed by the structure and operation of the present invention, in addition to the implementation of fire-line isothermal marking as just described, is additional fire line flagging to indicate regions, or locations, along the line which, in accordance with application of critical-alignment data, require special notice and attention. “Flagging” is a term which is employed herein to refer to a very useful manner in which such high priority regions may be presented visually to a user, such as a ground fire resource commander located, for example, at the remote ground site illustrated generally at 14 in FIG. 1.

Thus, one will see in FIG. 3 three flags shown at 62a, 64a, 66a represented by differently shaded rectangles. These rectangles illustrate the use of visual markers that may be presented in an overlay print, and/or on a video monitor, specifically associated with fire-line regions, or points, 48a, 48b, 48c, respectively, where critical alignment conditions have indicated that special attention needs to be directed. Flags, such as those shown at 62a, 64a, 66a, may have suitably chosen different appearances which are shapes, colors, etc., to relate their meanings to different levels of concern or severity which may be associated with those several fire-line regions. Such flags may be presented immediately upon the system of the present invention detecting their respective presences in accordance with the rules and criteria applied regarding critical-alignment data (as mentioned earlier), or, they may be called up and presented to a viewer in any appropriate fashion when called for. The flags may be associated, as an illustration, with detailed text further describing conditions at the marked locations, and such text materials are shown generally at 62b, 64b, 66b in FIG. 3.

An illustration of critical-alignment information/conditions which might result in priority flagging along fire line 48, say in the vicinity of point, or region 48a, is as follows:

(a) Fire-line isothermal temperature—470° F.

(b) Air temperature—90° F.

(c) Relative humidity—17%

(d) Wind speed—10-knots

(e) Wind direction—North, into new fuel

From the above description of the invention, the steps involved in practice of the invention are seen to include:

1. Gathering thermal and optical fire-line data along a substantially common line-of-sight which can be adjusted infinitely to occupy different angles in space.

2. Noting the angular disposition in space of such a line-of-sight.

3. Gathering critical-alignment atmospheric data, including air temperature relative humidity, and wind speed and direction.

4. Noting the distance from the observation site to an observed location along a fire-line perimeter.

5. Associated with all of the above data relevant GPS information.

6. Transmitting all such data from the observation location to a remote ground site for interpretation, and mapping for viewing.

7. Applying critical-alignment severity and priority parameters.

The system and method of the invention thus propose and offer a unique opportunity to provide detailed and highly relevant command and control information with respect to the management and directing of ground fire fighting resources. From an overhead support platform, typically in the form of an aircraft such as a helicopter, ground fire perimeter line isothermal conditions are readily detected over a wide range of a fire without requiring the overhead observation platform necessarily to be required to be directly over particular regions of a fire line. This is made so by virtue of the multi-angular articulation capability which is afforded optical and thermal imaging cameras that are supported on the frame of the aircraft. Important atmospheric data which is associated with important decision-making criteria involved with the concept of critical alignment are collected simultaneously with thermal and optical data relating to a fire line, and the data, all in digital form, is processed and downlink-transmitted to a control site for observation and decision making. This critical-alignment data adds a very important dimension to the visually presentable information respecting the condition of a ground fire perimeter line, and specifically enables the immediate flagging for attention, in a prioritized manner, of conditions along the fire line which need to be addressed with special, and often urgent and immediate attention.

Angle of line-of-site data, laser distance data, and GPS data, all linked to optical and thermal imagery, and critical-alignment atmosphere data, provide a powerful package of immediately and visually available information to those in charge of fighting ground fires.

The system and methodology of the invention are easily implemented with a variety of conventional sub-components that are assembled and operated in a unique fashion in accordance with practice of the invention. The system and method of the invention can be implemented in a wide variety of ways, and can easily be implemented and invoked in an after-fit manner with respect to currently available conventional ground fire-fighting equipment and modalities.

Accordingly, while a preferred and best mode embodiment of, and manner of practicing, the invention have been described and illustrated herein, it is appreciated that variations and modifications may be made without departing from the spirit of the invention.

I claim:

1. An airborne method for mapping and remotely reporting thermal and critical alignment evaluation data regarding the perimeter of a ground fire comprising
from an airborne platform which is deployed above and in selectable visual proximity to at least a portion of the perimeter line of a ground fire, gathering, along a substantially common line of sight, for remote transmission, linked thermal and optical imagery data interpretable for picturing positionally-defined thermal information relating to a selected region on and along such a perimeter-line portion,
substantially simultaneously, and in relation to said gathering with respect to such a selected region, additionally acquiring related critical-alignment, fire-information evaluation data including air temperature, relative humidity, wind speed, and wind direction, and
transmitting such thermal, optical and critical-alignment evaluation data to, and for reception and interpretation at, a remote site.

2. The method of claim 1 which further includes, with respect to such a selected perimeter-line region, noting, relative to the platform, the associated angular disposition in space of the associated substantially common line of sight along which such optical and thermal data for that region is gathered.

3. The method of claim 2 which further comprises enabling said optical and thermal imagery data gathering to take place selectively along an infinitely different number of selectable, spatially-oriented, substantially common lines of sight.

4. The method of claim 3 which further comprises effectively linking, relative to a selected perimeter-line region, the linear distance along the associated, substantially common line of sight between the selected region and the airborne platform.

5. The method of claim 1 which further includes associating with such optical, thermal, and critical-alignment evaluation data, GPS information which is effective to define the then-associated positions in space, relative to one another, of the selected region and the airborne platform.

6. Apparatus for temperature and critical-alignment evaluation mapping and remote reporting regarding a region of a ground-fire perimeter comprising
optical and thermal imaging structure mountable on a support platform for disposition and movement above and over a ground fire, operable to create a flow of imagery data which is interpretable for picturing, visually, the temperature-level-differentiated perimetral outline of at least a portion of the perimeter of such a fire,
atmospheric-condition sensing structure also mountable on such a platform for cooperative behavior in relation to said imaging structure, operable when so also mounted, to generate a flow of atmospheric-condition data containing information selected from the list including (a) air temperature, (b) relative humidity, (c) wind speed, and (d) wind direction, and
transmission reporting structure, operatively connected to said imaging structure and to said sensing structure, operable to transmit from the mentioned support platform to a remote location such imagery and atmospheric-condition data.

7. The apparatus of claim 6, wherein said support platform is an airborne platform.

8. The apparatus of claim 7 which further comprises GPS sensing structure also mountable on the mentioned platform, operable to produce GPS positional information which is relevant both to the mentioned optical and thermal imagery data and to the mentioned atmospheric-condition data, as such data is associated both with the imaged portion of a fire perimeter line, and with the then relative position of the support platform.

9. The apparatus of claim 6 which further comprises structure also mountable on the mentioned support platform for reporting, with respect to a selected optically- and thermally-imaged region of a ground-fire perimeter, the line-of-sight angular disposition in space which relates that region with the then position of the mentioned support platform.

10. An airborne system for mapping and remotely reporting temperature and critical alignment evaluation data regarding the perimeter of a ground fire comprising
an airborne platform deployable and movable above and over a ground fire,
coordinated optical and thermal imaging structure mounted on said platform, characterized effectively with a spatially angularly adjustable, substantially common, optical and thermal view axis, and operable to create a coordinated and remotely communicatable flow of linked optical and thermal imagery data which is interpretable for picturing the temperature-level-differentiated perimetral outline of at least a portion of such a ground fire, and
critical alignment data-gathering structure operatively associated with said imaging structure, also mounted on said support platform, and operable to produce, in relation to such a first-mentioned data flow, a like, remotely communicatable, companion data flow containing related critical-alignment evaluation data including information regarding (a) air temperature, (b) relative humidity, (c) wind speed, and (d) wind direction.

11. An airborne ground-fire data-gathering method comprising
from an airborne platform, gathering, for visual presentation and viewing purposes, related optical and thermal fire-perimeter data,
also from an airborne platform, gathering critical-alignment evaluation data which is associated with and relevant to such optical and thermal data, and
transmitting all of such data, effectively in a geophysically-linked manner, to a remote site for map-display viewing and evaluation.

12. The method of claim 11 which further comprises applying to such gathered data selected critical-alignment, severity-scale parameters which are employable generally to rank, from lower to higher, fire severity conditions in terms of prioritizing the deployment of fire-fighting resources, and from, and on the basis of, said applying, effectively map-highlighting, also for viewing and evaluation, selected parts of the gathered data which indicate certain higher-severity fire conditions.
